(19) United States
(12) Patent Application Publication
(10) Pub. No.: US 2016/0107283 A1
(43) Pub. Date: Apr. 21, 2016

(54) MACHINE TOOL

(71) Applicant: MITSUBISHI HEAVY INDUSTRIES, LTD., Tokyo (JP)

(72) Inventors: Hiroyuki DOMARU, Tokyo (JP); Hirohisa KURAMOTO, Tokyo (JP)

(73) Assignee: MITSUBISHI HEAVY INDUSTRIES, LTD., Tokyo (JP)

(21) Appl. No.: 14/856,732

(22) Filed: Sep. 17, 2015

(30) Foreign Application Priority Data
Oct. 17, 2014 (JP) 2014-212504

(51) Int. Cl. B23Q 11/00; B23Q 15/12; B23Q 17/22

(52) U.S. Cl. CPC B23Q 11/0028; B23Q 17/22; B23Q 15/12

(57) ABSTRACT

A machine tool includes: a column movably supported on a bed; a saddle movably supported on the column; a ram movably supported on the saddle; moving means for moving the column, the saddle, and the ram respectively along movement axes; a table where a workpiece is placed; table-tilt detecting means for detecting atilt of the table; and controlling means for controlling the moving means based on a detection result from the table-tilt detecting means.

### TECHNICAL FIELD

The present invention relates to a machine tool having an improved machining accuracy through an improvement in accuracy in relative positions of a tool and a workpiece during machining.

### BACKGROUND ART

Recently, demands for machine tools capable of high-accuracy machining have been increased more and more. The machining accuracy of a machine tool is greatly influenced by the geometric accuracy of the machine main body such as straightness or smoothness in movement of parts including a saddle configured to support a main spindle. The machining accuracy is determined by characteristics of a tool, machining conditions, and the like, as well as by the accuracy in relative positions of a tool and a workpiece during machining.

For example, in machine tools such as a horizontal boring machine, a saddle is movably supported on a side surface of a column. Hence, a vertical movement of the saddle along the column causes the column to deform (tilt). Moreover, the column, which is movably supported on a bed, influences the straightness of the bed, and thus moves with angular deviations (pitch, roll, yaw). This as well as a change in the ambient temperature also causes the column to deform (tilt).

A tilt of a column in this way shifts the tip end position of a tool, and decreases the accuracy in relative positions of the tool and a workpiece during machining, thereby decreasing the machining accuracy of the machine tool. Hence, a technique has been developed to prevent a decrease in the machining accuracy of a machine tool by detecting a tilt of a column due to a movement of a saddle, a movement of a column, or the like, and then moving for example the column or the saddle on the basis of the detection result to thereby correct a shifted tip end position of a tool <see, for example, Patent Literature 1>.

### CITATION LIST

### Patent Literature

{Patent Literature 1} Japanese Patent No. 5001870

### SUMMARY OF INVENTION

### Technical Problem

In a machine tool, a table where a workpiece is placed also tilts. This tilting of the table also decreases the accuracy in relative positions of a tool and a workpiece during machining, thereby decreasing the machining accuracy of the machine tool. For example, when a workpiece is placed on a table, if the center of gravity of the workpiece does not match the center of the table, this mismatch (eccentricity) of the center of gravity causes the table to deform (tilt). Moreover, the table, which is movably supported on a table bed, influences the straightness of the table bed, and thus moves with angular deviations. This as well as a change in the ambient temperature also causes the table to deform (tilt).

In this way, if a table is tilted according to a position where a workpiece is placed, a movement of the table, a change in the ambient temperature, or the like, the tilting decreases the aforementioned accuracy in relative positions of the workpiece and a tool during machining. Consequently, the machining accuracy of the machine tool is decreased in some cases.

The present invention has been made in view of the above-described problems. An object of the present invention is to prevent a decrease in a machining accuracy due to a tilt of a table.

### Solution to Problem

A first aspect of the invention for solving the above-described problems provides a machine tool including: a column movably supported on a bed; a saddle movably supported on the column; a ram movably supported on the saddle; moving means for moving the column, the saddle, and the ram respectively along movement axes; a table where a workpiece is placed; table-tilt detecting means for detecting a tilt of the table; and controlling means for controlling the moving means based on a detection result from the table-tilt detecting means.

A second aspect of the invention for solving the above-described problems provides the machine tool according to the first aspect of the invention, further including: a main spindle supported on the ram; and a tool attachably and detachably mounted on the main spindle. In the machine tool, the controlling means performs a control such that the moving means moves at least one of the column, the saddle, and the ram to correct a mismatch in relative positions of the tool and the workpiece.

A third aspect of the invention for solving the above-described problems provides the machine tool according to the first or the second aspect of the invention, in which the table-tilt detecting means includes height detecting means for detecting heights of multiple measurement points on the table to thereby obtain a tilt level of the table from a difference between the heights of the multiple measurement points detected by the height detecting means.

A fourth aspect of the invention for solving the above-described problems provides the machine tool according to the third aspect of the invention, in which the height detecting means is multiple distance sensors provided at positions below the table, and the measurement points are located on a lower surface of the table.

A fifth aspect of the invention for solving the above-described problems provides the machine tool according to any one of the first to the fourth aspects of the invention, further comprising column-tilt detecting means for detecting atilt of the column. In the machine tool, the controlling means controls the moving means based on detection results from the table-tilt detecting means and the column-tilt detecting means.

### Advantageous Effects of Invention

In the machine tool according to the first aspect of the invention, the table-tilt detecting means detects a deformation (tilt) of the table where a workpiece is placed, and the controlling means controls the moving means based on the detection result from the table-tilt detecting means. Accordingly, the column, the saddle, and the ram can be moved in accordance with the tilt of the table. Thus, even if there is a mismatch in relative positions of the workpiece and a tool, the mismatch can be corrected. This makes it possible to prevent a decrease in the machining accuracy due to the tilt of the table. In other words, the accuracy in relative positions of the tool and the workpiece is improved, making it possible to improve the machining accuracy of the machine tool.

In the machine tool according to the second aspect of the invention, the table-tilt detecting means detects a deformation (tilt) of the table where a workpiece is placed, and the controlling means controls the moving means based on the detection result from the table-tilt detecting means. Accordingly, a mismatch in relative positions of the tool and the workpiece due to the tilt of the table can be corrected. Thus, it is possible to prevent a decrease in the machining accuracy due to the tilt of the table. In other words, the accuracy in relative positions of the tool and the workpiece is improved, making it possible to improve the machining accuracy of the machine tool.

In the machine tool according to the third aspect of the invention, the height detecting means detects heights of multiple measurement points on the table to obtain a tilt level of the table from a difference between the detected heights of the multiple measurement points. This makes it possible to simplify the structure of the table-tilt detecting means, a program, and so forth.

In the machine tool according to the fourth aspect of the invention, the multiple distance sensors provided at positions below the table measure measurement points on the lower surface of the table. This can make the structure of the table-tilt detecting means, a program, and so forth simple and inexpensive.

In the machine tool according to the fifth aspect of the invention, the column-tilt detecting means detects a deformation (tilt) of the column, and the controlling means controls the moving means based on the detection results from the table-tilt detecting means and the column-tilt detecting means. Accordingly, a mismatch in relative positions of the tool and the workpiece due to both the tilt of the column and the tilt of the table can be corrected. Thus, it is possible to prevent a decrease in the machining accuracy due to the tilt of the column and the tilt of the table. In other words, the accuracy in relative positions of the tool and the workpiece is further improved, making it possible to improve the machining accuracy of the machine tool.

### BRIEF DESCRIPTION OF DRAWINGS

FIG. 1 is an explanatory view showing a structure of a machine tool according to Embodiment 1.

FIG. 2 is an explanatory view showing a column, in an X-Y plane view, of the machine tool according to Embodiment 1.

FIG. 3 is an explanatory view showing the column, in a Y-Z plane view, of the machine tool according to Embodiment 1.

FIG. 4 is an explanatory view showing a rotary table, in an X-Y plane view, of the machine tool according to Embodiment 1.

FIG. 5 is an explanatory view showing the rotary table, in a Y-Z plane view, of the machine tool according to Embodiment 1.

FIG. 6 is a control block diagram showing an NC unit of the machine tool according to Embodiment 1.

FIG. 7 is an explanatory view showing a calibration of a digital level of the machine tool according to Embodiment 1.

FIG. 8 is an explanatory view showing a calibration of a digital level of the machine tool according to Embodiment 1.

### DESCRIPTION OF EMBODIMENTS

Hereinafter, an embodiment of a machine tool according to the present invention will be described in detail with reference to the attached drawings. It is a matter of course that the present invention is not limited to the following Embodiment, and it is needless to say that various modifications can be made without departing from the spirit of the present invention.

### Embodiment 1

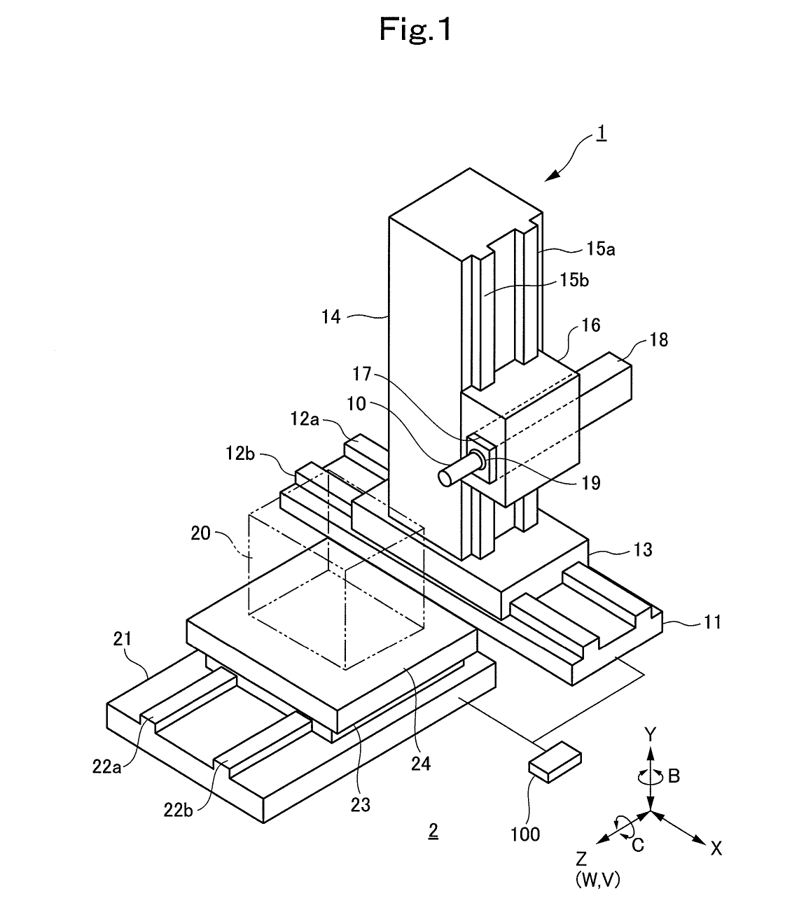

A structure of a machine tool according to Embodiment 1 of the present invention will be described with reference to FIGS. 1 to 6.

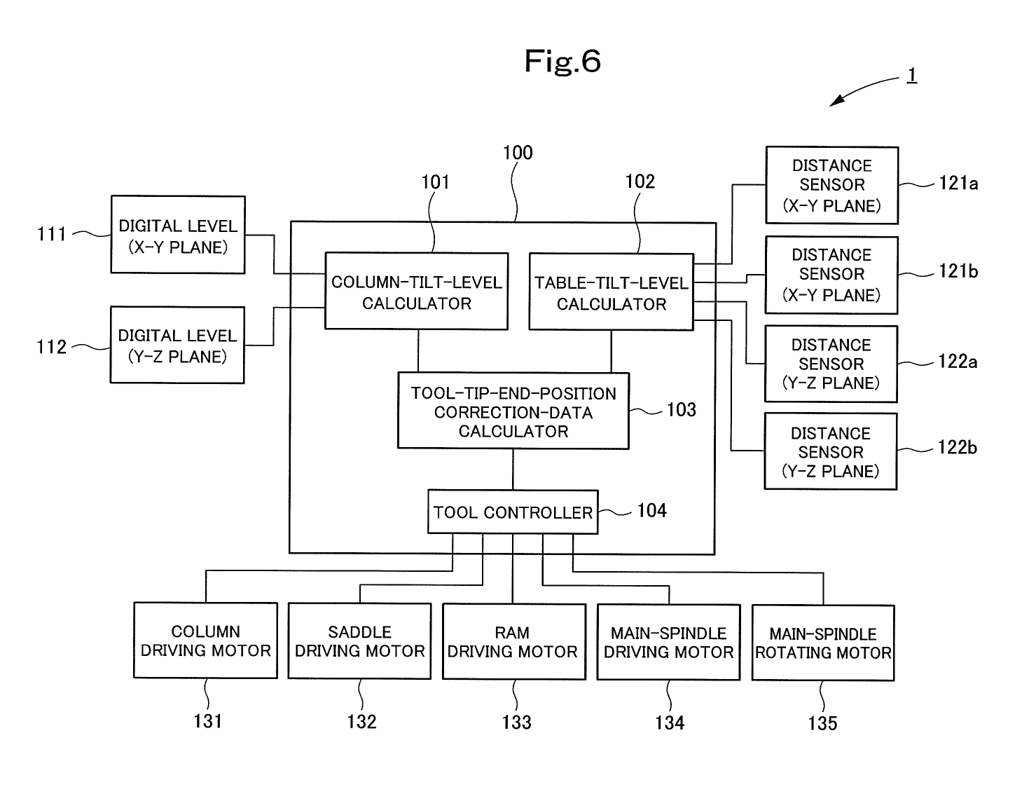

As shown in FIG. 1, a machine tool 1, which is a large horizontal boring machine, is provided with a bed 11 fixed to a floor surface (base) 2. The bed 11 has an upper surface provided with a pair of right and left guide rails 12a, 12b extending in a horizontal X-axis direction. The guide rails 12a, 12b are configured to support a column base 13 slidably in the X-axis direction. The column base 13 has an upper surface provided with a column 14 standing thereon. Moreover, the machine tool 1 is provided with a column driving motor 131 (see FIG. 6). By driving the column driving motor 131, the column base 13 and the column 14 move in the X-axis direction along the guide rails 12a, 12b through an unillustrated feeding screw mechanism or the like (see FIG. 1).

The column 14 has a side surface provided with a pair of right and left guide rails 15a, 15b extending in a vertical Y-axis direction. The guide rails 15a, 15b are configured to support a saddle 16 slidably in the Y-axis direction. Moreover, the machine tool 1 is provided with a saddle driving motor 132 (see FIG. 6). By driving the saddle driving motor 132, the saddle 16 moves in the Y-axis direction along the guide rails 15a, 15b through an unillustrated feeding screw mechanism or the like (see FIG. 1).

The saddle 16 has a guide hole 17 formed therethrough in a horizontal Z-axis direction. Inside the guide hole 17, a ram 18 is supported slidably in the Z-axis direction. Moreover, the machine tool 1 is provided with a ram driving motor 133 (see FIG. 6). By driving the ram driving motor 133, the ram 18 and a main spindle 19 to be described later move in the Z-axis direction along the guide hole 17 through an unillustrated feeding screw mechanism or the like (see FIG. 1).

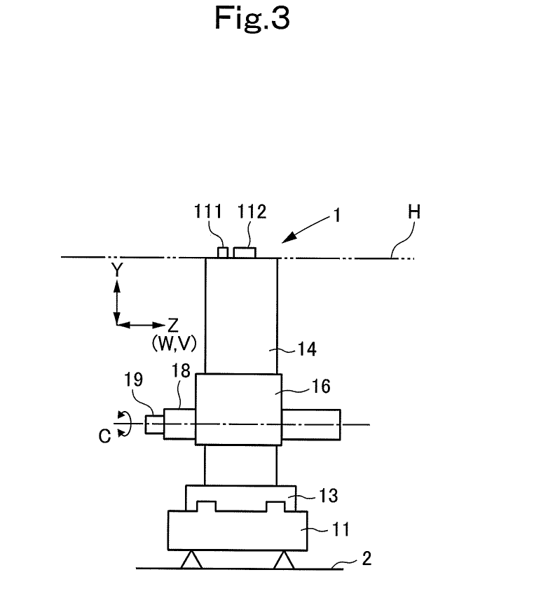

As shown in FIGS. 1 and 3, inside the ram 18, the main spindle 19 is supported rotatably about a horizontal rotation axis C and slidably in a W-axis direction parallel to the Z axis. A tool 10 for predetermined machining is attachably and detachably mounted on a tip end of the main spindle 19. The main spindle 19 is capable of moving together with the ram 18 in the Z-axis direction by driving the ram driving motor 133 as described above, and is also capable of moving away from the ram 18 in the W-axis direction through an unillustrated feeding screw mechanism or the like by driving a main-spindle driving motor 134 (see FIG. 6) provided to the machine tool 1. Moreover, the machine tool 1 is provided with a main-spindle rotating motor 135 (see FIG. 6). By driving the main-spindle rotating motor 135, the main spindle 19 rotates about the rotation axis C inside the ram 18 (see FIG.

Further, as shown in FIG. 1, a table bed 21 is provided in front of the bed 11, and fixed to the floor surface (base) 2. The table bed 21 has an upper surface provided with a pair of front and rear guide rails 22a, 22b extending in a V-axis direction parallel to the Z axis. The guide rails 22a, 22b are configured to support a table base 23 slidably in the V-axis direction. Furthermore, on an upper portion of the table base 23, a rotary table 24 is supported rotatably about a vertical rotation axis B. In addition, a workpiece (machining object) 20 is attachably and detachably mounted (placed) on an upper surface of the rotary table 24. Thus, by driving an unillustrated table driving motor, the table base 23 and the rotary table 24 move in the V-axis direction through an unillustrated feeding screw mechanism or the like. Further, by driving an unillustrated table rotating motor, the rotary table 24 rotates about the rotation axis B.

Moreover, as shown in FIGS. 1 and 6, the machine tool 1 is provided with an NC unit 100 for controlling the entire machine tool 1. The NC unit 100 is provided with a tool controller 104 for controlling the movement of the tool 10. To the tool controller 104 are connected the column driving motor 131, the saddle driving motor 132, the ram driving motor 133, the main-spindle driving motor 134, the main-spindle rotating motor 135, and so on described above. To put it differently, the tool controller 104 is configured to change the movement direction and the movement speed of the tool 10, and also to adjust the movement distance and the revolutions thereof.

Further, the NC unit 100 is provided with an unillustrated workpiece controller for controlling the movement of the workpiece 20. To the workpiece controller are connected the aforementioned unillustrated table driving motor and unillustrated table rotating motor, and so on. To put it differently, the workpiece controller is configured to change the movement direction and the movement speed of the workpiece 20, and also to adjust the movement distance and the revolutions thereof.

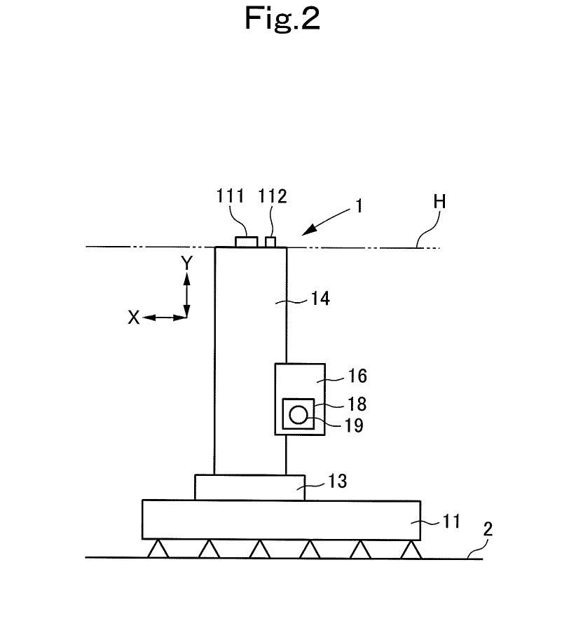

Furthermore, as shown in FIGS. 2 and 3, the column 14 has an upper surface provided with two digital levels 111, 112. The one digital level 111 is configured to detect an X-axis component of a tilt of the upper surface of the column 14 (i.e., deformation (tilt) of the column 14) relative to a horizontal line H in an X-Y plane. The other digital level 112 is configured to detect a Z-axis component of the tilt of the upper surface of the column 14 (i.e., deformation (tilt) of the column 14) relative to a horizontal line H in a Y-Z plane.

As shown in FIG. 6, these two digital levels 111, 112 are connected to a column-tilt-level calculator 101 provided in the NC unit 100. The column-tilt-level calculator 101 is configured to calculate a tilt (tilt level) of the column 14 from detection results of the two digital levels 111, 112. Moreover, the column-tilt-level calculator 101 is connected to a tool-tip-end-position correction-data calculator 103 to be described later.

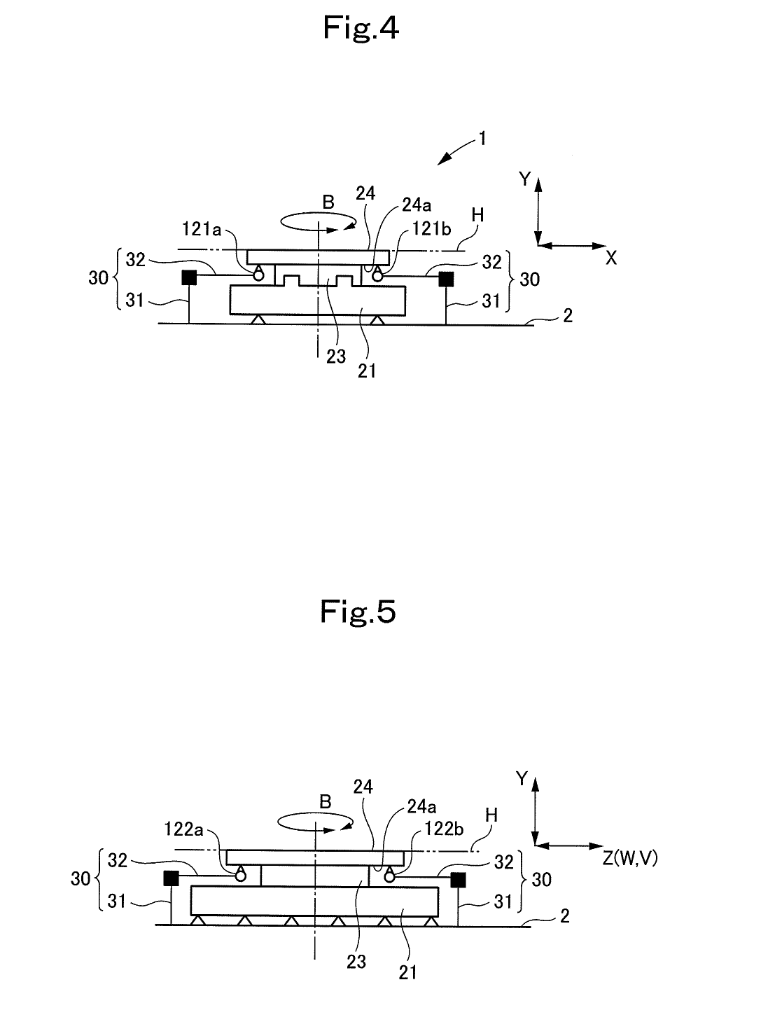

Meanwhile, as shown in FIGS. 4 and 5, the machine tool 1 is provided with multiple (in the present embodiment, four) distance sensors 121a, 121b, 122a, 122b. The two distance sensors 121a, 121b are configured to detect an X-axis component of a tilt of the rotary table 24 (i.e., deformation (tilt) of the rotary table 24) relative a horizontal line H in an X-Y plane (see FIG. 4). The other two distance sensors 122a, 122b are configured to detect a V-axis (Z-axis) component of the tilt of the rotary table 24 (i.e., deformation (tilt) of the rotary table 24) relative to a horizontal line H in a Y-Z plane (see FIG. 5).

Specifically, the distance sensors 121a, 121b, 122a, 122b are each positioned at a predetermined height from the floor surface (base) 2 with a sensor fixing jig 30, and capable of measuring a distance from the predetermined height to a lower surface 24a of the rotary table 24. The X-axis component of the deformation (tilt) of the rotary table 24 is obtained from a difference between values (heights of the measurement points) measured by the distance sensors 121a and 121b. The Z-axis component of the deformation (tilt) of the rotary table 24 is obtained from a difference between values (heights of the measurement points) measured by the distance sensors 122a and 122b.

Thus, the distance sensors 121a and 121b are preferably placed apart from each other in the X-axis direction as shown in FIG. 4, and the distance sensors 122a and 122b are preferably placed apart from each other in the V-axis (Z-axis) direction as shown in FIG. 5. Additionally, to simplify the calculation by a table-tilt-level calculator 102 to be described later, the distance sensors 121a and 121b are preferably arranged in such a manner that a straight line connecting the two is parallel to the X axis, while the distance sensors 122a and 122b are preferably arranged in such a manner that a straight line connecting the two is parallel to the V axis (Z axis).

It is a matter of course that the table-tilt detecting means according to the present invention is not limited to one using the four distance sensors 121a, 121b, 122a, 122b as in the present embodiment. For example, a digital level or the like may be used like the column-tilt detecting means. Alternatively, at least three distance sensors may be provided as long as the deformation (tilt) of the rotary table 24 can be obtained by the table-tilt detecting means. The measurement points may be set at, for example, an upper surface of the rotary table 24 other than the lower surface 24a.

Moreover, the sensor fixing jig 30 includes: a standing portion 31 fixed to the floor surface (base) 2 near the table bed 21 and extending vertically therefrom; and an extending portion 32 extending horizontally from an upper end portion of the standing portion 31 toward the rotary table 24. This configuration prevents interference with the movements of the table base 23 and the rotary table 24 in the V-axis direction. Each of the distance sensors 121a, 121b, 122a, 122b is attached to a tip end of the extending portion 32 of the sensor fixing jig 30, and located below and near a corner (end portion) of the rotary table 24.

As shown in FIG. 6, these multiple distance sensors 121a, 121b, 122a, 122b are connected to the table-tilt-level calculator 102 provided in the NC unit 100. The table-tilt-level calculator 102 is configured to calculate a tilt (tilt level) of the rotary table 24 from the detection results of the multiple distance sensors 121a, 121b, 122a, 122b, that is, differences between heights of multiple measurement points (unillustrated) on the lower surface 24a of the rotary table 24. Additionally, the table-tilt-level calculator 102 is connected to the tool-tip-end-position correction-data calculator 103 to be described later.

The tool-tip-end-position correction-data calculator 103 to which the column-tilt-level calculator 101 and the table-tilt-level calculator 102 described above are connected is configured to calculate correction data for correcting a shift of a tip end position of the tool 10 due to tilt levels, from the tilt (tilt level) of the column 14 calculated by the column-tilt-level calculator 101 and the tilt (tilt level) of the rotary table 24 calculated by the table-tilt-level calculator 102.

The tool-tip-end-position correction-data calculator 103 is connected to the tool controller 104. The tool controller 104 is configured to control the driving of the column driving motor 131, the saddle driving motor 132, the ram driving motor 133, the main-spindle driving motor 134, and the main-spindle rotating motor 135 on the basis of the correction data calculated by the tool-tip-end-position correction-data calculator 103. To put it differently, the tool controller 104 performs a control such that at least one of the column 14, the saddle 16, the ram 18, and the main spindle 19 is moved to correct a shift of the tip end position of the tool 10 (mismatch in relative positions of the workpiece 20 and the tool 10) due to the tilt of the column 14 and the tilt of the table 24, thereby preventing a decrease in the machining accuracy of the machine tool 1.

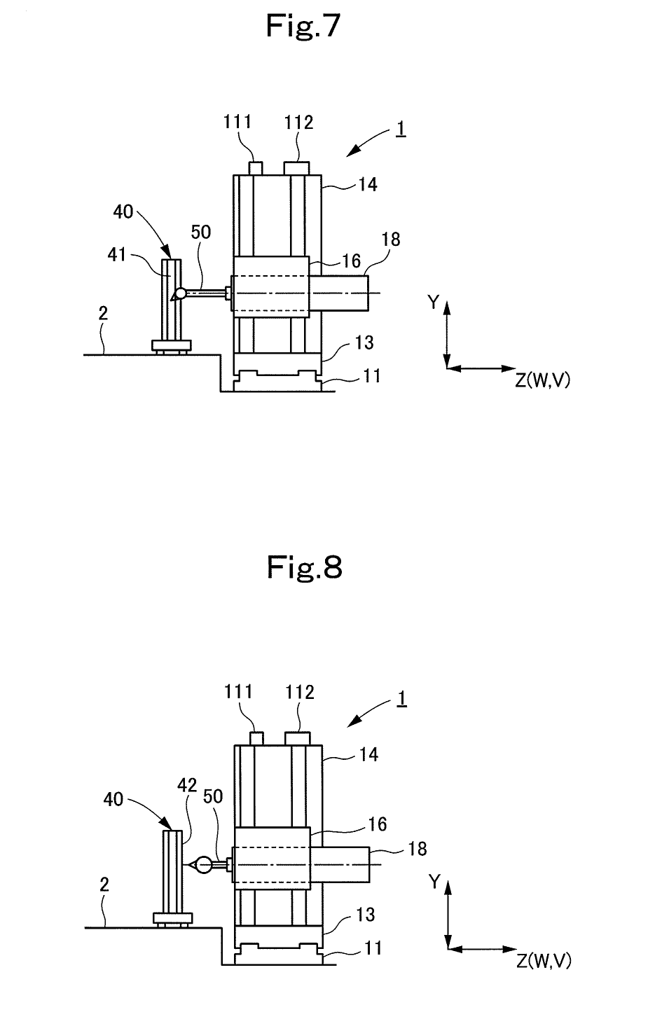

Additionally, a calibration jig 40 is placed on the floor surface (base) 2 near the column 14 as shown in FIGS. 7 and 8. The calibration jig 40 is used to calibrate the digital levels 111, 112 of the machine tool 1. Specifically, a dial gauge 50 is mounted on a tip end portion of the ram 18. Then, while a tip end of the dial gauge 50 abuts against a front surface (Y-Z reference plane) 41 of the calibration jig 40, the saddle 16 is vertically moved to calibrate the one digital level 111 (see FIG. 7). Meanwhile, while the tip end of the dial gauge 50 abuts against a side surface (X-Y reference plane) 42 of the calibration jig 40, the saddle 16 is vertically moved to calibrate the other digital level 112 (see FIG. 8).

Operations of the machine tool 1 according to Embodiment 1 of the present invention will be described with reference to FIGS. 1 to 6.

When the workpiece 20 is to be machined in the machine tool 1, the workpiece 20 is mounted on the upper surface of the rotary table 24 as shown in FIG. 1, and the unillustrated table driving motor is driven to move the table base 23 in the V-axis direction along the guide rails 22a, 22b. Thereby, the workpiece 20 is moved to a machining position.

While the tool 10 mounted on the main spindle 19 is rotated about the rotation axis C by driving the main-spindle rotating motor 135, the column driving motor 131, the saddle driving motor 132, the ram driving motor 133, and the main-spindle driving motor 134 are individually driven to combine the movement of the column 14 (the column base 13) in the X-axis direction, the movement of the saddle 16 in the Y-axis direction, the movement of the ram 18 in the Z-axis direction, and the movement of the main spindle 19 in the W-axis direction, so that the tool 10 is moved. Moreover, as necessary, the unillustrated table driving motor and the unillustrated table rotating motor are individually driven to combine the movement of the workpiece 20 in the V-axis direction and the rotation of the workpiece 20 about the rotation axis B, so that the workpiece 20 is moved. In this manner, the workpiece 20 is machined with the tool 10.

In this respect, since the saddle 16 is movably supported on the side surface of the column 14 in the machine tool 1, the vertical movement of the saddle 16 along the column 14 may cause the column 14 to deform (tilt). Moreover, the column 14 (the column base 13) movably supported on the bed 11 moves with angular deviations (pitch, roll, yaw) under the influence of the straightness of the bed 11. This as well as a change in the ambient temperature may also cause the column 14 to deform (tilt).

In this way, when the column 14 is tilted according to a movement of the saddle 16, a movement of the column 14 (the column base 13), a change in the ambient temperature, or the like, the digital level 111 detects an X-axis component of the tilt, and the digital level 112 detects a Z-axis component of the tilt.

Further, in the machine tool 1, the rotary table 24 where the workpiece 20 is placed may also tilt. When the workpiece 20 is placed on the rotary table 24, if the center of gravity of the workpiece 20 does not match the center of the rotary table 24, this mismatch (eccentricity) of the center of gravity causes the rotary table 24 to deform (tilt). Moreover, the rotary table 24 movably supported on the table bed 21 influences the straightness of the table bed 21, and thus moves with angular deviations. This as well as a change in the ambient temperature may also cause the rotary table 24 to deform (tilt).

In this way, when the rotary table 24 is tilted according to a position where the workpiece 20 is placed, a movement of the rotary table 24, a change in the ambient temperature, or the like, the distance sensors 121a, 121b detect an X-axis component of the tilt, and the distance sensors 122a, 122b detect a Z-axis component of the tilt.

As described above, in the machine tool 1, a tilt of the column 14 and a tilt of the rotary table 24 are detected by the digital levels 111, 112, and the distance sensors 121a, 121b, 122a, 122b at all times.

The column-tilt-level calculator 101 calculates a tilt level of the column 14 from the detection results detected by the digital levels 111, 112, that is, the X-axis component and the Z-axis component of the tilt of the column 14. The result (tilt level) is sent to the tool-tip-end-position correction-data calculator 103.

On the other hand, the table-tilt-level calculator 102 calculates atilt level of the rotary table 24 from the detection results detected by the distance sensors 121a, 121b and the distance sensors 122a, 122b. Specifically, the measurement values (distance values) measured by the distance sensors 121a, 121b, 122a, 122b indicate heights of the measurement points on the lower surface 24a of the rotary table 24. An X-axis component of the tilt of the rotary table 24 is obtained from a difference between the values (heights of the measurement points) measured by the distance sensors 121a and 121b, and a Z-axis component of the tilt of the rotary table 24 is obtained from a difference between the values (heights of the measurement points) measured by the distance sensors 122a and 122b. Then, the table-tilt-level calculator 102 calculates a tilt level of the rotary table 24 from the X-axis component and the Z-axis component of the tilt of the rotary table 24. The result (tilt level) is sent to the tool-tip-end-position correction-data calculator 103.

The tool-tip-end-position correction-data calculator 103 calculates correction data for correcting a shift of a tip end position of the tool 10 relative to the workpiece 20, from the calculation results calculated by the column-tilt-level calculator 101 and the table-tilt-level calculator 102, that is, the tilt level of the column 14 and the tilt level of the rotary table 24.

Next, based on the correction data calculated by the tool-tip-end-position correction-data calculator 103, the tool controller 104 drives the column driving motor 131, the saddle driving motor 132, the ram driving motor 133, and the main-spindle driving motor 134. To put it differently, the movement of the column 14 (the column base 13) in the X-axis direction, the movement of the saddle 16 in the Y-axis direction, the movement of the ram 18 in the Z-axis direction, and the movement of the main spindle 19 in the W-axis direction are combined to move the tool 10. This movement corrects the shift of the tip end position of the tool 10 relative to the workpiece 20, that is, a mismatch in relative positions of the tool 10 and the workpiece 20. Thus, the accuracy in relative positions of the tool 10 and the workpiece 20 is improved, making it possible to prevent a decrease in the machining accuracy of the machine tool 1.

As has been described above, the machine tool 1 according to the present embodiment is capable of correcting the tip end position of the tool 10 on the basis of the tilt of the column 14 and the tilt of the rotary table 24, in other words, by adding the tilt of the rotary table 24 to the tilt of the column 14. Accordingly, a mismatch in the relative positions of the tool 10 and the workpiece 20 during machining occurs less frequently, making it possible to prevent a decrease in the machining accuracy of the machine tool 1.

Note that, in the present embodiment, the column driving motor 131, the saddle driving motor 132, the ram driving motor 133, and the main-spindle driving motor 134 are moving means for moving the column 14 (the column base 13), the saddle 16, the ram 18, and the main spindle 19 along the respective movement axes of the X axis, the Y axis, the Z axis, and the W axis. The NC unit 100 including the tool-tip-end-position correction-data calculator 103 and the tool controller 104 is controlling means for controlling the column driving motor 131, the saddle driving motor 132, the ram driving motor 133, and the main-spindle driving motor 134.

Moreover, in the present embodiment, the distance sensors 121a, 121b, 122a, 122b are height detecting means for detecting heights of multiple measurement points (unillustrated) on the lower surface 24a of the rotary table 24. The distance sensors 121a, 121b, 122a, 122b and the table-tilt-level calculator 102 constitute the table-tilt detecting means. The digital levels 111, 112 and the column-tilt-level calculator 101 constitute the column-tilt detecting means.

### REFERENCE SIGNS LIST

1 MACHINE TOOL

2 FLOOR SURFACE (BASE)

10 TOOL

11 BED

12a GUIDE RAIL

12b GUIDE RAIL

13 COLUMN BASE

14 COLUMN

15a GUIDE RAIL

15b GUIDE RAIL

16 SADDLE

17 GUIDE HOLE

18 RAM

19 MAIN SPINDLE

20 WORKPIECE

21 TABLE BED

22a GUIDE RAIL

22b GUIDE RAIL

23 TABLE BASE

24 ROTARY TABLE

30 SENSOR FIXING JIG

31 STANDING PORTION

32 EXTENDING PORTION

100 NC UNIT (CONTROLLING MEANS)

101 COLUMN-TILT-LEVEL CALCULATOR (COLUMN-TILT DETECTING MEANS)

102 TABLE-TILT-LEVEL CALCULATOR (TABLE-TILT DETECTING MEANS)

103 TOOL-TIP-END-POSITION CORRECTION-DATA CALCULATOR (CONTROLLING MEANS)

104 TOOL CONTROLLER (CONTROLLING MEANS)

111 DIGITAL LEVEL (COLUMN-TILT DETECTING MEANS)

112 DIGITAL LEVEL (COLUMN-TILT DETECTING MEANS)

121a DISTANCE SENSOR (TABLE-TILT DETECTING MEANS, HEIGHT DETECTING MEANS)

121b DISTANCE SENSOR (TABLE-TILT DETECTING MEANS, HEIGHT DETECTING MEANS)

122a DISTANCE SENSOR (TABLE-TILT DETECTING MEANS, HEIGHT DETECTING MEANS)

122b DISTANCE SENSOR (TABLE-TILT DETECTING MEANS, HEIGHT DETECTING MEANS)

131 COLUMN DRIVING MOTOR (MOVING MEANS)

132 SADDLE DRIVING MOTOR (MOVING MEANS)

133 RAM DRIVING MOTOR (MOVING MEANS)

134 MAIN-SPINDLE DRIVING MOTOR (MOVING MEANS)

135 MAIN-SPINDLE ROTATING MOTOR

1. A machine tool comprising:
a column movably supported on a bed;
a saddle movably supported on the column;
a ram movably supported on the saddle;
moving means for moving the column, the saddle, and the ram respectively along movement axes;
a table where a workpiece is placed;
table-tilt detecting means for detecting a tilt of the table; and
controlling means for controlling the moving means based on a detection result from the table-tilt detecting means.

2. The machine tool according to claim 1, further comprising:
a main spindle supported on the ram; and
a tool attachably and detachably mounted on the main spindle, wherein
the controlling means performs a control such that the moving means moves at least one of the column, the saddle, and the ram to correct a mismatch in relative position of the tool and the workpiece.

3. The machine tool according to claim 1, wherein the table-tilt detecting means comprises height detecting means for detecting heights of a plurality of measurement points on the table to thereby obtain a tilt level of the table from a difference between the heights of the plurality of measurement points detected by the height detecting means.

4. The machine tool according to claim 3, wherein
the height detecting means is a plurality of distance sensors provided at positions below the table, and
the measurement points are located on a lower surface of the table.

5. The machine tool according to claim 1, further comprising column-tilt detecting means for detecting a tilt of the column, wherein
the controlling means controls the moving means based on detection results from the table-tilt detecting means and the column-tilt detecting means.
